(19) United States
(12) Patent Application Publication
(10) Pub. No.: US 2015/0240146 A1
(43) Pub. Date: Aug. 27, 2015

(54) DOWNHOLE TOOLS HAVING HYDROPHOBIC WEAR AND EROSION RESISTANT COATINGS, AND METHODS OF MANUFACTURING SUCH TOOLS

(71) Applicant: Baker Hughes Incorporated, Houston, TX (US)

(72) Inventors: Vivekanand Sista, The Woodlands, TX (US); Steven R. Radford, The Woodlands, TX (US); Suresh G. Patel, The Woodlands, TX (US)

(21) Appl. No.: 14/187,124

(22) Filed: Feb. 21, 2014

(51) Int. Cl. C09K 8/52; E21B 34/00; E21B 17/00; E21B 10/00

(52) U.S. Cl. CPC C09K 8/52; E21B 10/00; E21B 34/00; E21B 17/00; C09K 2208/32; C09K 2208/12

(57) ABSTRACT

Downhole tools for use in wellbores include a layer of material over a body, wherein the layer is relatively more hydrophobic at higher temperatures and pressures, such as those encountered downhole within the wellbore, compared to the hydrophobicity at ambient conditions. For example, a downhole tool may include a body having a first composition, and a layer of material disposed at the surface of the body. The layer of material may comprise a boride or a nitride. An exposed surface of the layer of material exhibits a first relatively higher hydrophobicity at a temperature of 150° C. and a pressure of 1,300 psi, and exhibits a second relatively lower hydrophobicity at 20° C. and 14.70 psi. Methods of forming downhole tools include forming such a layer of material at a surface of a body of a downhole tool.

### TECHNICAL FIELD

Embodiments of the present disclosure relate to downhole tools used during drilling, completion and production phases of, for example, obtaining hydrocarbons from a producing formation with a subterranean wellbore, and, more particularly, to downhole tools having coatings formulated to reduce scale buildup and balling while maintaining wear and erosion resistance, and to methods of forming such downhole tools.

### BACKGROUND

Wellbores are formed in subterranean formations for various purposes including, for example, extraction of oil and gas from the subterranean formation and extraction of geothermal heat from the subterranean formation. Wellbores may be formed in a subterranean formation using a drill bit such as, for example, an earth-boring rotary drill bit. Different types of earth-boring rotary drill bits are known in the art including, for example, fixed-cutter bits (which are often referred to in the art as “drag” bits), rolling-cutter bits (which are often referred to in the art as “rock” bits), diamond-impregnated bits, and hybrid bits (which may include, for example, both fixed cutters and rolling cutters). The drill bit is rotated and advanced into the subterranean formation. As the drill bit rotates, the cutters or abrasive structures thereof cut, crush, shear, and/or abrade away the formation material to form the wellbore. A diameter of the wellbore drilled by the drill bit may be defined by the cutting structures disposed at the largest outer diameter of the drill bit.

The drill bit is coupled, either directly or indirectly, to an end of what is referred to in the art as a “drill string,” which comprises a series of elongated tubular segments connected end-to-end that extends into the wellbore from the surface of the formation. Often various tools and components, including the drill bit, may be coupled together at the distal end of the drill string at the bottom of the wellbore being drilled. This assembly of tools and components is referred to in the art as a “bottom hole assembly” (BHA).

The drill bit may be rotated within the wellbore by rotating the drill string from the surface of the formation, or the drill bit may be rotated by coupling the drill bit to a downhole motor, which is also coupled to the drill string and disposed proximate the bottom of the wellbore. The downhole motor may comprise, for example, a hydraulic Moineau-type motor having a shaft, to which the drill bit is mounted, that may be caused to rotate by pumping fluid (e.g., drilling mud or fluid) from the surface of the formation down through the center of the drill string, through the hydraulic motor, out from nozzles in the drill bit, and back up to the surface of the formation through the annular space between the outer surface of the drill string and the exposed surface of the formation within the wellbore.

It is known in the art to use what are referred to in the art as “reamer” devices (also referred to in the art as “hole opening devices” or “hole openers”) in conjunction with a drill bit as part of a bottom hole assembly when drilling a wellbore in a subterranean formation. In such a configuration, the drill bit operates as a “pilot” bit to form a pilot bore in the subterranean formation. As the drill bit and bottom hole assembly advances into the formation, the reamer device follows the drill bit through the pilot bore and enlarges the diameter of, or “reams,” the pilot bore.

The bodies of downhole tools, such as drill bits and reamers, are often provided with fluid courses, such as “junk slots,” to allow drilling mud (which may include drilling fluid and formation cuttings generated by the tools that are entrained within the fluid) to pass upwardly around the bodies of the tools into the annular space within the wellbore above the tools outside the drill string. Drilling tools used for casing and liner drilling usually have smaller fluid courses and are particularly prone to balling, causing a lower rate of penetration.

When drilling a wellbore, the formation cuttings may adhere to, or “ball” on, the surface of the drill bit, or reamer or other downhole tool. The cuttings may accumulate on the cutting elements and the surfaces of the drill bit or other tool, and may collect in any void, gap, or recess created between the various structural components of the bit. This phenomenon is particularly enhanced in formations that fail plastically, such as in certain shales, mudstones, siltstones, limestones and other relatively ductile formations. The cuttings from such formations may become mechanically packed in the aforementioned voids, gaps, or recesses on the of the drill bit. In other cases, such as when drilling certain shale formations, the adhesion between formation cuttings and a surface of a drill bit or other tool may be at least partially based on chemical bonds therebetween. When a surface of a drill bit becomes wet with water in such formations, the bit surface and clay layers of the shale may share common electrons. A similar sharing of electrons is present between the individual sheets of the shale itself. A result of this sharing of electrons is an adhesive-type bond between the shale and the bit surface. Adhesion between the formation cuttings and the bit surface may also occur when the charge of the bit face is opposite the charge of the formation. The oppositely charged formation particles may adhere to the surface of the bit. Moreover, particles of the formation may be compacted onto surfaces of the bit or mechanically bonded into pits or trenches etched into the bit by erosion and abrasion during the drilling process.

Similarly, tooling used downhole during the completion and production phases of the wellbore can be subject to scale buildup and balling over time. The buildup of scale and balling can lead to decreased operational efficiency, increased power consumption, and/or decreased usable lifetime for the tooling.

### BRIEF SUMMARY

In some embodiments, the present disclosure includes downhole tools for use in wellbores that include a layer of material over a body, wherein the layer is relatively more hydrophobic at higher temperatures and pressures, such as those encountered downhole within the wellbore, compared to the hydrophobicity of the layer at ambient conditions. For example, in some embodiments, a downhole tool includes a body having a first composition, and a layer of material disposed at the surface of the body. The layer of material has a second composition differing from the first composition of the body. The layer of material may comprise a boride or a nitride. An exposed surface of the layer of material exhibits a first relatively higher hydrophobicity at a temperature of 150° C. and a pressure of 1,300 psi, and exhibits a second, relatively lower hydrophobicity, at 20° C. and 14.70 psi.

In additional embodiments, the present disclosure includes methods of manufacturing such downhole tools. For example, in accordance with some embodiments, a method of forming a downhole tool includes forming a layer of material at a surface of a body of the downhole tool. The layer of material is fowled such that it comprises a boride or a nitride having a composition that differs from a composition of the body. The composition of the boride or nitride is selected such that an exposed surface of the layer of material exhibits a first relatively higher hydrophobicity at a temperature of 150° C. and a pressure of 1,300 psi, and exhibits a second relatively lower hydrophobicity at 20° C. and 14.70 psi.

### BRIEF DESCRIPTION OF THE SEVERAL VIEWS OF THE DRAWINGS

While the specification concludes with claims particularly pointing out and distinctly claiming what are regarded as embodiments of the present invention, various features and advantages of embodiments of the disclosure may be more readily ascertained from the following description of example embodiments provided with reference to the accompanying drawings, in which:

FIG. 1 is a simplified and schematically illustrated cross-sectional side view illustrating various downhole tools within a wellbore in a subterranean formation;

FIG. 2 is a simplified and schematically illustrated side view of a portion of a body of a downhole tool that includes a layer of material at a surface of a body of the downhole tool; and

FIG. 3 illustrates a perspective view of a downhole tool in the form of an earth-boring rotary drag bit that includes a layer of material as described herein and illustrated in FIG. 2 at a surface of a bit body of the earth-boring rotary drag bit.

### DETAILED DESCRIPTION

The illustrations presented herein are not actual views of any particular downhole tool, drill bit, or component of such a tool or bit, but are merely idealized representations which are employed to describe embodiments of the present invention.

As discussed in further detail below, embodiments of the present disclosure relate to downhole tools for use in wellbores. The downhole tools include a layer of material disposed at a surface of a body of the downhole tool that is relatively hydrophobic, and additionally may be relatively wear-resistant and/or erosion-resistant. The hydrophobicity of the layer of material may increase with increasing temperature and pressure, such that the layer of material exhibits a relatively higher hydrophobicity at depths within the wellbore where relatively higher temperatures and pressures are encountered relative to the surface of the formation. Thus, an exposed surface of the layer of material may exhibit a first relatively higher hydrophobicity at a temperature of 150° C. and a pressure of 1,300 psi, and may exhibit a second relatively lower hydrophobicity at 20° C. and 14.70 psi. The layer of material may have a composition that differs from a composition of the body over which it is disposed. The layer of material may comprise, for example, a boride or nitride, as discussed in further detail below.

As used herein, the term “body” of a downhole tool means and includes not only a primary body, housing or other structure of a downhole tool, but a component part of such downhole tool, whether or not such component part is separately formed from another component part, or integral therewith. In other words, a body of a downhole tool having a layer of material on only a portion thereof according to an embodiment of the disclosure is encompassed by the disclosure. Similarly, a surface of a downhole tool having a layer of material thereon according to an embodiment may be an interior surface, an exterior surface, or a surface extending from an interior to an exterior of the downhole tool.

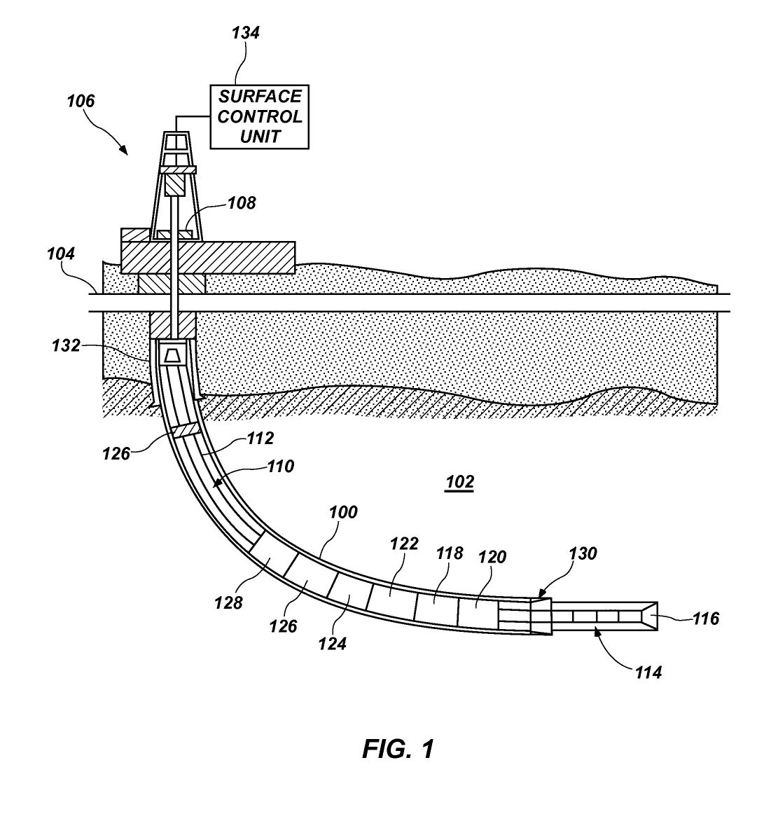

FIG. 1 is a schematic diagram showing a wellbore 100 formed in a subterranean formation 102. The wellbore 100 shown in FIG. 1 is a partially formed wellbore 100 that is currently undergoing further drilling to extend the depth of the wellbore 100, as well as enlargement of the diameter of the wellbore 100. Thus, a drilling system 106 used to form the wellbore 100 includes components at a surface 104 of the formation 102, as well as components that extend into, or are disposed within the wellbore 100. The drilling system 106 includes a rig 108 at the surface 104 of the formation 102, and a drill string 110 extending into the formation 102 from the rig 104. The drill string 110 includes a tubular member 112 that carries a bottomhole assembly (BHA) 114 at a distal end thereof. The tubular member 112 may be made up by joining drill pipe sections in an end-to-end configuration.

The BHA 114 may include, as non-limiting examples, a drill bit 150, a steering device 118, a drilling motor 120, a sensor sub 122, a bidirectional communication and power module (BCPM) 124, a stabilizer 126, a formation evaluation (FE) module 128, and a hole enlargement device 130.

The BHA 110 may be rotated within the wellbore 100 using the drilling motor 120. The drilling motor 120 may comprise, for example, a hydraulic Moineau-type motor having a shaft, to which the BHA 110 is coupled, that may be caused to rotate by pumping fluid (e.g., drilling mud or fluid) from the surface 104 of the formation 102 down through the center of the drill string 110, through the drilling motor 120, out through nozzles in the drill bit 150, and back up to the surface 104 of the formation 102 through the annular space between the outer surface of the drill string 110 and the exposed surface of the formation 102 within the wellbore 100 (or the exposed inner surface of any casing 132 within the wellbore 100). Alternatively, the BHA 110 may be rotated within the wellbore 100 by rotating the drill string 106 from the surface 104 of the formation 102.

A controller 134 may be placed at the surface 104 for receiving and processing downhole data. The controller 134 may include a processor, a storage device for storing data, and computer programs. The processor accesses the data and programs from the storage device and executes the instructions contained in the programs to control the drilling system 106 during drilling operations.

As is also shown in FIG. 1, one or more sections of casing 132 may also be disposed within one or more sections of the wellbore 100.

Embodiments of the present disclosure may include any downhole tool employed within a wellbore 100 in a subterranean formation 102, such as any of the tools disposed within the wellbore 100 as previously described. Furthermore, downhole tools include those used in the formation and enlargement of wellbores 100, as well as those used in the completion of wellbores 100 and operation of completed wellbores 100 for production. As used herein, the term “downhole tool” means and includes any man-made element that is inserted into a wellbore 100, or intended for use within a wellbore 100, in the forming of, enlargement of, completion of, maintenance of, or operation of (i.e., production of) a wellbore 100.

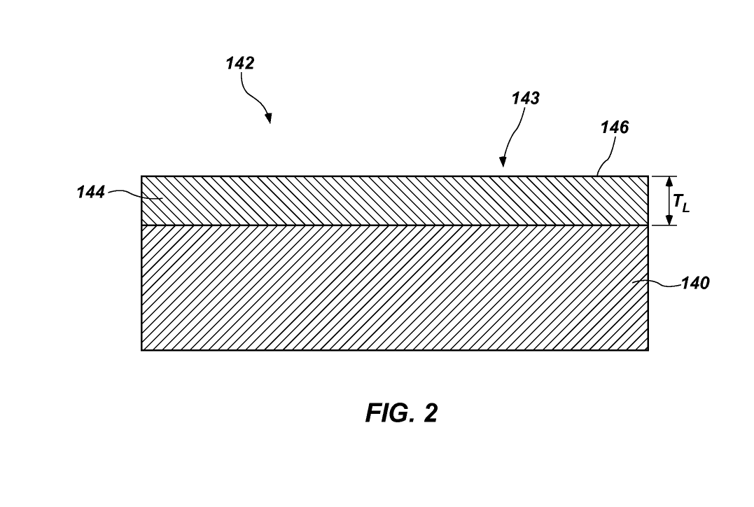

FIG. 2 is a simplified and schematically illustrated cross-sectional side view of a portion of a body 140 of an earth-boring tool 142. A layer of material 144 is disposed at the surface 143 of the earth-boring tool 142. The body 140 of the earth-boring tool 142 has a first composition, and the layer of material 144 has a second composition differing from the first composition of the body 140.

As non-limiting examples, the body 140 may comprise a metal, a metal alloy, a ceramic, or a composite material. As non-limiting specific examples, the body 140 may comprise an iron alloy (e.g., steel), a cemented tungsten carbide composite material (e.g., cobalt-cemented tungsten carbide), or polycrystalline diamond.

As previously mentioned, the layer of material 144 may comprise a material, such as a nitride or a boride, that exhibits a hydrophobicity that increases with increasing temperature and/or pressure, such that the layer of material exhibits a relatively higher hydrophobicity at depths within the wellbore where relatively higher temperatures and pressures are encountered relative to the surface of the formation. Thus, an exposed surface 146 of the layer of material 144 may exhibit a first relatively higher hydrophobicity at a temperature of 150° C. and a pressure of 1,300 psi, and may exhibit a second relatively lower hydrophobicity at 20° C. and 14.70 psi (i.e., room temperature and atmospheric pressure).

In some embodiments, the layer of material 144 may comprise a nitride, such as a chromium nitride (e.g., CrN, Cr₂N, or AlₓCr₍₂₋ₓ₎N). In embodiments in which the layer of material 144 comprises a nitride, the layer of material 144 may have an average layer thickness T_{L} of between about 3.0 μm and about 50.0 μm.

The hydrophobicity of the surface 146 of the layer of material 144 may be determined over a range of temperatures and pressures by measuring a contact angle between the surface 146 of the layer of material 144 and sessile or pendant droplets thereon using a high pressure drop shape analyzer, such as the Drop Shape Analyzer sold as model DSA100HP by KRUSS GmbH of Hamburg, Germany. The contact angle may be determined using optical methods known in the art, wherein images of the sessile or pendant droplets are acquired, and measurements of the droplet are acquired from the images.

In embodiments in which the layer of material 144 comprises a chromium nitride such as CrN, Cr₂N, or AlₓCr₍₂₋ₓ₎N, the layer of material 144 may exhibit a contact angle with respect to a droplet of water surrounded by oil (polyalphaolephin (PAO) viscosity 4 oil) of about 130° or more, about 145° or more, or even 160° or more at temperatures extending from about 50° C. to about 250° C. and pressures up to about 25,000 psi. Such chromium nitride layers of material 144 may exhibit a contact angle with respect to a droplet of oil (polyalphaolephin (PAO) viscosity 4 oil) surrounded by water of about 100° or more, of about 105° or more, or even 110° or more at temperatures extending from about 50° C. to about 250° C. and pressures up to about 25,000 psi. Thus, the layer of material 144 may be both hydrophobic and oleophobic under downhole conditions, and the hydrophobicity and oleophobicity may increase with increasing temperature and pressure.

A layer of material 144 comprising a chromium nitride such as CrN, Cr₂N, or AlₓCr₍₂₋ₓ₎N also may be relatively wear-resistant, erosion-resistant, and may exhibit non-stick and/or low friction properties.

The layer of material 144 comprising such a chromium nitride may also exhibit an Ra surface roughness of between about 60 μin. and about 100 μin, or even between about 70 μin. and about 90 μin, and a Vickers microhardness HV_{0.3} of at least about 1,600 HV_{0.3}.

Such chromium nitride materials may be deposited by various methods including, for example, physical vapor deposition (PVD) techniques. For example, methods of depositing chromium nitride material layers using PVD processes are disclosed in Y.-S. Yang, et al., Annealing effect on the hydrophobic property of Cr₂N coatings, Surface & Coatings Technology (2012), http://dx.doi.org/10.1016/j.surfcoat.2012.09.016, and in Y.-S. Yang, et al., Optimizing hydrophobic and wear-resistant properties of Cr—Al—N coatings, Thin Solid Films (2012), http://dx.doi.org/10.1016/j.tsf.2012.11.042, each of which is incorporated herein in its entirety by this reference. Furthermore, the hydrophobicity of such a chromium nitride layer of material 144 may be increased by performing a post-deposition annealing process such as any of those described in the aforementioned articles. For example, the chromium nitride layer of material 144 may be annealed at a temperature or temperatures of between about 300° C. and about 900° C. for a period of between about thirty minutes (30 min) and about four hours (4.0 hr.) to increase the hydrophobicity of the chromium nitride layer of material 144.

In additional embodiments, the layer of material 144 may comprise a boride, such as a transition metal boride. As non-limiting examples, the layer of material 144 may comprise one or more of an iron boride, a chromium boride, a nickel boride, a molybdenum boride, and a titanium boride.

In embodiments in which the layer of material 144 comprises a boride, the layer of material 144 may have an average layer thickness T_{L} of between about 3 μm and about 1,000 μm.

In embodiments in which the layer of material 144 comprises a boride such as molybdenum boride (MoB), the layer of material 144 may exhibit a contact angle with respect to a droplet of water surrounded by oil (polyalphaolephin (PAO) viscosity 4 oil) of about 130° or more, about 145° or more, or even 160° or more at temperatures extending from about 50° C. to about 250° C. and pressures up to about 25,000 psi. Such molybdenum boride layers of material 144 may exhibit a contact angle with respect to a droplet of oil (polyalphaolephin (PAO) viscosity 4 oil) surrounded by water of about 110° or more, about 115° or more, or even 120° or more at temperatures extending from about 50° C. to about 250° C. and pressures up to about 25,000 psi.

A layer of material 144 comprising a transition metal boride such as molybdenum boride also may be relatively wear-resistant, erosion-resistant, and may exhibit non-stick and/or low friction properties, similar to the chromium nitride materials previously described herein.

The layer of material 144 comprising such a molybdenum boride may also exhibit an Ra surface roughness of between about 110 μin. and about 150 μin, or even between about 120 μin. and about 140 μin, and a Vickers microhardness HV_{0.3} of at least about 2,000 HV_{0.3}.

Such transition metal boride materials may be deposited by various methods known in the art including, for example, physical vapor deposition (PVD) techniques.

In additional embodiments, the layer of material 144 may comprise a composite material comprising any of the aforementioned chromium nitride or transition metal boride materials, infused with a fluoropolymer, such as polytetrafluoroethylene (PTFE). Such a composite material may exhibit enhanced resistance to scale buildup and balling.

As previously mentioned, the body 140 shown in FIG. 2 may comprise a body 140 of any downhole tool 142. As non-limiting examples, the body 140 may comprise a body 142 of a drill bit (e.g., a fixed cutter drill bit, a rolling cutter drill bit, a hybrid fixed-cutter and rolling cutter drill bit, etc.), a coring bit, an expandable bit, an eccentric bit, a reamer, an underreamer, an artificial lift, a subsurface safety valve, a sensor tool (e.g., a measurement while drilling (MWD) tool or a logging while drilling (LWD) tool), a rotary steerable system, a cross-over, a jar, a drill pipe, a drill collar, casing, liner, so-called “fishing” tooling and equipment, a rotor or stator for a mud motor, a sensor plate for a mud pulse device, and downhole completion, production and maintenance/remediation equipment and tooling (e.g., blow out preventers, valves, diverters, down-hole pumps, screens, etc.).

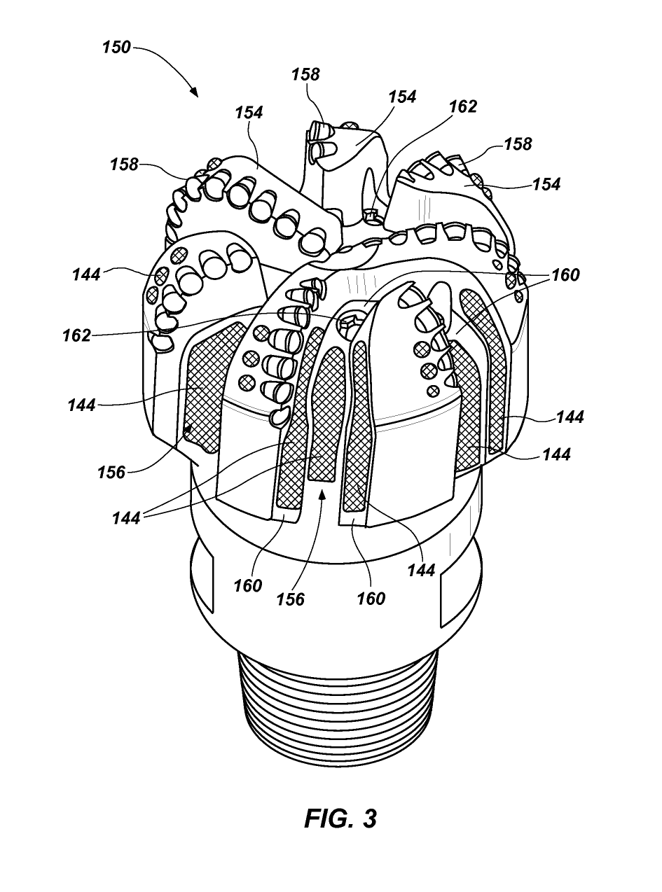

As one non-limiting example of one such downhole tool, FIG. 3 illustrates an earth-boring rotary drag bit 150 according to the present disclosure. The drag bit 150 has a bit body 140 that includes a plurality of blades 154 separated from one another by fluid courses 156. The portions of the fluid courses 156 that extend along the radial sides (the “gage” areas of the drill bit 150) are often referred to in the art as “junk slots.” A plurality of cutting elements 158 are mounted to each of the blades 154. The bit body 140 further includes a generally cylindrical internal fluid plenum and fluid passageways that extend through the bit body 140 to an exterior surface 160 of the bit body 140. Nozzles 162 may be secured within the fluid passageways proximate the exterior surface 160 of the bit body 140 for controlling the hydraulics of the drill bit 150 during drilling.

During a drilling operation, the drill bit 150 may be coupled to a drill string 110 (FIG. 1). As the drill bit 150 is rotated within the wellbore 100, drilling fluid may be pumped down the drill string 110, through the internal fluid plenum and fluid passageways within the bit body 140 of the drill bit 150, and out from the drill bit 150 through the nozzles 162. Formation cuttings generated by the cutting elements 158 of the drill bit 150 may be carried with the drilling fluid through the fluid courses 156, around the drill bit 150, and back up the wellbore 100 through the annular space within the wellbore 100 and outside the drill string 116.

As shown in FIG. 3, a layer of material 144, which is represented in FIG. 3 by the cross-hatched areas for purposes of illustration, may be disposed over at least a portion of the exterior surface 160 of the bit body 140. The layer of material 144, due to its hydrophobicity, may reduce accumulation of formation cuttings thereon when the drill bit 150 is used to form a wellbore 100. The layer of material 144 may be provided at, for example, regions of the drill bit 150 that are susceptible to balling, such as pinch points (e.g., locations at which blades converge), cuttings trajectory points (e.g., locations at which cuttings converge), and bit shank (i.e., where the bit head and threaded pin meet). For example, the layer of material 144 may be disposed over one or more regions of the exterior surface 160 of the bit body 140 of the drill bit 150 within the fluid courses 156, as shown in FIG. 3. Such regions may include, for example, rotationally leading surfaces of the blades 154, rotationally trailing surfaces of the blades, under the cutting elements 158 where chip flow occurs, and behind the cutting elements 158. In additional embodiments, the layer of material 144 may form a generally continuous coating disposed over at least substantially all exterior surfaces of the bit body 140 of the drill bit 150. The bit body 140 and the layer of material 144 may have a boride or nitride composition as previously described herein with reference to FIG. 2.

The layers of material 144 described herein may provide enhanced resistance to scale buildup and balling in or on tools used in downhole environments, while maintaining desirable levels of wear and erosion resistance. Thus, but employing such layers of material on downhole tools, power consumption may be reduced, operational efficiency may be increased, and/or the serviceable life of the downhole tools may be extended.

Additional non-limiting example embodiments of the disclosure are set forth below.

Embodiment 1: A downhole tool, comprising: a body having a first composition; and a layer of material disposed at the surface of the body, the layer of material having a second composition differing from the first composition of the body, the layer of material comprising a boride or nitride, an exposed surface of the layer of material exhibiting a first relatively higher hydrophobicity at a temperature of 150° C. and a pressure of 1,300 psi, and exhibiting a second relatively lower hydrophobicity at 20° C. and 14.70 psi.

Embodiment 2: The downhole tool of Embodiment 1, wherein the layer of material comprises a nitride.

Embodiment 3: The downhole tool of Embodiment 2, wherein the nitride is selected from the group consisting of CrN, Cr₂N, and AlₓCr₍₂₋ₓ₎N.

Embodiment 4: The downhole tool of any one of Embodiments 1 through 3, wherein the layer of material has an average layer thickness of between about 3.0 μm and about 50.0 μm.

Embodiment 5: The downhole tool of any one of Embodiments 1 through 4, wherein the layer of material exhibits a contact angle of about 130° or more relative to a water droplet in oil-based drilling mud at the temperature of 150° C. and a pressure of 1,300 psi.

Embodiment 6: The downhole tool of any one of Embodiments 1 through 5, wherein the layer of material is wear resistant.

Embodiment 7: The downhole tool of any one of Embodiments 1 through 6, wherein the layer of material exhibits an Rₐ surface roughness of between about 60 μin. and about 100 μin.

Embodiment 8: The downhole tool of any one of Embodiments 1 through 7, wherein the layer of material exhibits a Vickers microhardness of at least about 1,600 HV_{0.3}.

Embodiment 9: The downhole tool of Embodiment 1, wherein the layer of material comprises a boride.

Embodiment 10: The downhole tool of Embodiment 9, wherein the boride comprises a transition metal boride.

Embodiment 11: The downhole tool of Embodiment 10, wherein the transition metal boride is selected from the group consisting of an iron boride, a chromium boride, a nickel boride, a molybdenum boride, and a titanium boride.

Embodiment 12: The downhole tool of Embodiment 11, wherein the transition metal boride comprises a molybdenum boride.

Embodiment 13: The downhole tool of any one of Embodiments 1 and 9 through 12, wherein the layer of material has an average layer thickness of between about 3 μm and about 1,000 μm.

Embodiment 14: The downhole tool of any one of Embodiments 1 and 9 through 13, wherein the layer of material exhibits a contact angle of about 130° or more relative to a water droplet in oil at the temperature of 150° C. and a pressure of 1,300 psi.

Embodiment 15: The downhole tool of any one of Embodiments 1 and 9 through 14, wherein the layer of material is wear resistant.

Embodiment 16: The downhole tool of any one of Embodiments 1 and 9 through 15, wherein the layer of material exhibits an Rₐ surface roughness of between about 110 μin. and about 150 μin.

Embodiment 17: The downhole tool of any one of Embodiments 1 and 9 through 16, wherein the layer of material exhibits a Vickers microhardness of at least about 2,000 HV_{0.3}.

Embodiment 18: The downhole tool of any one of Embodiments 1 through 17, wherein the first composition of the body comprises at least one of an iron alloy, a cemented tungsten carbide composite material, and polycrystalline diamond.

Embodiment 19: The downhole tool of any one of Embodiments 1 through 18, wherein the body comprises a body of a downhole tool selected from the group consisting of a drill bit, a coring bit, a reamer, an artificial lift, a subsurface safety valve, a sensor, a rotary steerable system, a jar, a drill pipe, a drill collar, casing, and liner.

Embodiment 20: A method of forming a downhole tool as recited in any one of Embodiments 1 through 19.

Embodiment 21: A method of forming a downhole tool, the method comprising forming a layer of material at a surface of a body of the downhole tool, and forming the layer of material to comprise a boride or a nitride having a composition differing a composition of the body, the composition of the boride or nitride selected such that an exposed surface of the layer of material exhibits a first relatively higher hydrophobicity at a temperature of 150° C. and a pressure of 1,300 psi, and exhibits a second relatively lower hydrophobicity at 20° C. and 14.70 psi.

Although the foregoing description contains many specifics, these are not to be construed as limiting the scope of the present disclosure, but merely as providing certain exemplary embodiments. Similarly, other embodiments may be devised which do not depart from the scope of the present invention. For example, features described herein with reference to one embodiment also may be provided in others of the embodiments described herein. The scope of the invention is, therefore, indicated and limited only by the appended claims and their legal equivalents, rather than by the foregoing description. All additions, deletions, and modifications to embodiments of the disclosure, as described and illustrated herein, which fall within the meaning and scope of the claims, are encompassed by the present invention.

What is claimed is:

1. A downhole tool, comprising:
a body having a first composition; and
a layer of material disposed at the surface of the body, the layer of material having a second composition differing from the first composition of the body, the layer of material comprising a boride or nitride, an exposed surface of the layer of material exhibiting a first relatively higher hydrophobicity at a temperature of 150° C. and a pressure of 1,300 psi, and exhibiting a second relatively lower hydrophobicity at 20° C. and 14.70 psi.

2. The downhole tool of claim 1, wherein the layer of material comprises a nitride.

3. The downhole tool of claim 2, wherein the nitride is selected from the group consisting of CrN, Cr₂N, and AlₓCr₍₂₋ₓ₎N.

4. The downhole tool of claim 2, wherein the layer of material has an average layer thickness of between about 3.0 μm and about 50.0 μm.

5. The downhole tool of claim 2, wherein the layer of material exhibits a contact angle of about 130° or more relative to a water droplet in oil at the temperature of 150° C. and a pressure of 1,300 psi.

6. The downhole tool of claim 2, wherein the layer of material is wear resistant.

7. The downhole tool of claim 2, wherein the layer of material exhibits an Rₐ surface roughness of between about 60 μin. and about 100 μin.

8. The downhole tool of claim 2, wherein the layer of material exhibits a Vickers microhardness of at least about 1,600 HV_{0.3}.

9. The downhole tool of claim 1, wherein the layer of material comprises a boride.

10. The downhole tool of claim 9, wherein the boride comprises a transition metal boride.

11. The downhole tool of claim 10, wherein the transition metal boride is selected from the group consisting of an iron boride, a chromium boride, a nickel boride, a molybdenum boride, and a titanium boride.

12. The downhole tool of claim 11, wherein the transition metal boride comprises a molybdenum boride.

13. The downhole tool of claim 9, wherein the layer of material has an average layer thickness of between about 3 μm and about 1,000 μm.

14. The downhole tool of claim 9, wherein the layer of material exhibits a contact angle of about 130° or more relative to a water droplet in oil at the temperature of 150° C. and a pressure of 1,300 psi.

15. The downhole tool of claim 9, wherein the layer of material is wear resistant.

16. The downhole tool of claim 9, wherein the layer of material exhibits an Rₐ surface roughness of between about 110 μin. and about 150 μin.

17. The downhole tool of claim 9, wherein the layer of material exhibits a Vickers microhardness of at least about 2,000 HV_{0.3}.

18. The downhole tool of claim 1, wherein the first composition of the body comprises at least one of an iron alloy, a cemented tungsten carbide composite material, and polycrystalline diamond.

19. The downhole tool of claim 1, wherein the body comprises a body of a downhole tool selected from the group consisting of a drill bit, a coring bit, a reamer, an artificial lift, a subsurface safety valve, a sensor, a rotary steerable system, a jar, a drill pipe, a drill collar, casing, and liner.

20. A method of forming a downhole tool, the method comprising forming a layer of material at a surface of a body of the downhole tool, and forming the layer of material to comprise a boride or a nitride having a composition differing a composition of the body, the composition of the boride or nitride selected such that an exposed surface of the layer of material exhibits a first relatively higher hydrophobicity at a temperature of 150° C. and a pressure of 1,300 psi, and exhibits a second relatively lower hydrophobicity at 20° C. and 14.70 psi.
